(19) United States
(12) Patent Application Publication
(10) Pub. No.: US 2014/0257846 A1
(43) Pub. Date: Sep. 11, 2014

(54) IDENTIFYING POTENTIAL AUDIT TARGETS IN FRAUD AND ABUSE INVESTIGATIONS

(71) Applicant: INTERNATIONAL BUSINESS MACHINES CORPORATION, Armonk, NY (US)

(72) Inventors: Keith B. Hermiz, Arlington, VA (US); Vijay S. Iyengar, Cortlandt Manor, NY (US); Ramesh Natarajan, Pleasantville, NY (US)

(73) Assignee: International Business Machines Corporation, Armonk, NY (US)

(21) Appl. No.: 13/793,165

(22) Filed: Mar. 11, 2013

(51) Int. Cl. G06F 19/00

(52) U.S. Cl. CPC G06F 19/328
USPC 705/3; 705/2

(57) ABSTRACT

Detecting fraud in the health care industry includes selecting a given focus scenario (e.g., prescription rate in a certain drug therapeutic class) for audit analysis, and constructing baseline models with the appropriate normalizations to describe the expected behavior within the focus area. These baseline models are then used, in conjunction with statistical hypothesis testing, to identify entities whose behavior diverges significantly from their expected behavior according to the baseline models. A Likelihood Ratio (LR) score over the relevant claims with respect to the baseline model is obtained for each entity, and the p-value significance of this score is evaluated to ensure that the abnormal behavior can be identified at the specified level of statistical significance. The approach may be used as part of a preliminary computer-aided audit process in which the relevant entities with the abnormal behavior are identified with high selectivity for a subsequent human-intensive audit investigation.

### FIELD

The present disclosure generally relates to the field of computer-aided auditing and investigating, particularly to auditing systems, methods and computer-program products for purposes of fraud detection in the health care industry, e.g., health care claims such as prescription drug claims.

### BACKGROUND

The audit process for health care claims must take into account two somewhat conflicting concerns. On the one hand, health care costs must be controlled by identifying and eliminating error, fraud and waste in the claims settlement process. On the other hand, within reason, the claims review process should not inhibit or constrain legitimate medical professionals and patients from achieving the best possible health outcomes based on the most effective treatments. This intrinsic dilemma is an understated yet overriding concern for the design and implementation of a computer-aided audit methodology for health care claims.

Most computer-aided audit systems invariably rely on business rules of thumb or heuristics to discover instances of fraud and abuse, although this approach may have many limitations in the health care claims context. For instance, these heuristics are often formulated in an ad hoc fashion, and may not adequately incorporate the relevant domain knowledge and data modeling expertise. Furthermore, a rigid application of these heuristics may be inappropriate in certain situations, and may lead to a large number of claims reviews that will undermine the utility of the computer-aided audit process. Lastly, while this approach may be quite adequate for subverting the known or obvious patterns of fraud and abuse, it may be less than adequate for unanticipated and emerging patterns, or for sophisticated “under the radar” schemes, since respectively, these either completely bypass or completely conform to the prevailing heuristics. In the light of these limitations, this class of computer-aided audit approaches may not have the required flexibility and effectiveness for the health care claims context.

Many aspects of the investigative process for detecting fraud and abuse in health care claims are human intensive, and rely on the expertise of a small number of professionals with the specialized knowledge and forensic skills

### SUMMARY OF THE INVENTION

A computer-aided audit technique for detecting fraud in the health care industry.

In one embodiment, a method for computer-aided audit analysis comprises: formulating a set of scenarios each relating to a collection of encounter instances for a health care domain focus area; collecting supporting data elements for analyzing activity of the health care domain focus area in an analysis period; creating a baseline model associated with each scenario in the set of scenarios using the data elements to create an expected rate of activity for one or more the entities with respect to the focus area, the entities comprising: patients, prescribing entities (prescribers), and pharmacy entities (pharmacies), the set of scenarios relating to instances of encounters between the patients, prescribers and pharmacies, wherein the patient and prescriber encounters include issuing prescriptions, by a prescriber, to patients for a focus area drug item; predicting from the created baseline model an expected amount of activity concerning the focus area in the analysis period for an entity; and computing a score for the entity using the baseline model, the score used to assess abnormal behavior with respect to the focus area activity, wherein a computing system including at least one processor unit performs one or more of: the collecting, baseline model creating, predicting and scoring.

Further, a system for computer-aided audit analysis is provided that comprises: one or more content sources providing content; a programmed processing unit for communicating with the content sources and configured to: formulate a set of scenarios each relating to a collection of encounter instances for a health care domain focus area; collect supporting data elements for analyzing activity of the health care domain focus area in an analysis period; create a baseline model associated with each scenario in the set of scenarios using the data elements to create an expected rate of activity for one or more the entities with respect to the focus area, the entities comprising: patients, prescribing entities (prescribers), and pharmacy entities (pharmacies), the set of scenarios relating to instances of encounters between the patients, prescribers and pharmacies, wherein the patient and prescriber encounters include issuing prescriptions, by a prescriber, to patients for a focus area drug item; predict from the created baseline model an expected amount of activity concerning the focus area in the analysis period for an entity; and compute a score for the entity using the baseline model, the score used to assess abnormal behavior with respect to the focus area activity.

A computer program product is provided for performing operations. The computer program product includes a storage medium readable by a processing circuit and storing instructions run by the processing circuit for running a method. The storage medium readable by a processing circuit is not only a propagating signal. The method is the same as listed above.

### BRIEF DESCRIPTION OF THE DRAWINGS

Various objects, features and advantages of the present invention will become apparent to one skilled in the art, in view of the following detailed description taken in combination with the attached drawings, in which:

FIG. 1 depicts a schematic of a methodology for identifying entities with potential abnormal claims behavior;

FIG. 2 depicts a computer system 50 including processing components for detecting fraud according to the processing methods shown in FIG. 1;

FIG. 3A depicts one embodiment of a rule-generation algorithm implemented in rule-generator component of FIG. 2;

FIG. 3B depicts one embodiment of an entity scoring algorithm implemented in conjunction with a scoring component of FIG. 2;

FIG. 4 conceptually depicts a method 200 for the greedy term selection;

FIG. 5 shows a plot 300 of an example the Receiver Operating Characteristic (ROC) curve for the four focus drug classes of the example described herein;

FIG. 6 depicts a Table 350 illustrating the key characteristics of the baseline model including the area under the ROC curve (AUC);

FIG. 7 depicts a graph 500 plotting a measure of segment size on the x-axis (e.g., log scale) and the rate of narcotic analgesic drug prescriptions on the y-axis (log scale);

FIG. 8 is a Table 600 depicting characteristics of entities identified by the model as being abnormally excessive in the prescribing of narcotic analgesics example, and shows corresponding computed entity scores;

FIG. 9 shows example results 700 generated as output of the processing described herein computed as a ranked list of the top potential target entities for an example focus drug class; and

FIG. 10 illustrates a portion of a computer system, including a CPU and a conventional memory in which the present invention may be embodied.

### DETAILED DESCRIPTION

A system, method and computer program product for detecting fraud in the health care industry, particularly for conducting an audit in prescription drug claims.

In particular, a computer-aided audit technique for detecting fraud in the health care industry may be part of a preliminary screening process to identify a smaller set of targets for detailed investigation and prosecution.

The computer-aided audit technique is credible and effective as the potential audit targets are provided with high selectivity. In one aspect, these targets may be ranked in some order that emphasizes the severity of the departure from expected audit norms, and if the results are supported by a deep-dive analysis, that provides the background evidence for investigating the top-ranked audit targets. The high selectivity in the implemented method for identifying potential audit targets ensures that the number of false positives (in the top-ranked targets) and false negatives (in the bottom-ranked targets) is small.

In the context of health care claims, as the confirmation of the false positives and false negatives is expensive and time-consuming, the computer-aided audit methodology identifies potential audit targets with high selectivity in the first effort itself, without any expectation of corrective feedback on the results. The method incorporates a high level of domain expertise supported by all the relevant data elements in the computer-aided audit analysis, which is particularly challenging in the health care domain, where the claims circumstances are often obscured by the complex medical diagnoses, the immense variety of procedures and treatment protocols, and by the pharmacological subtleties of the prescribed medications.

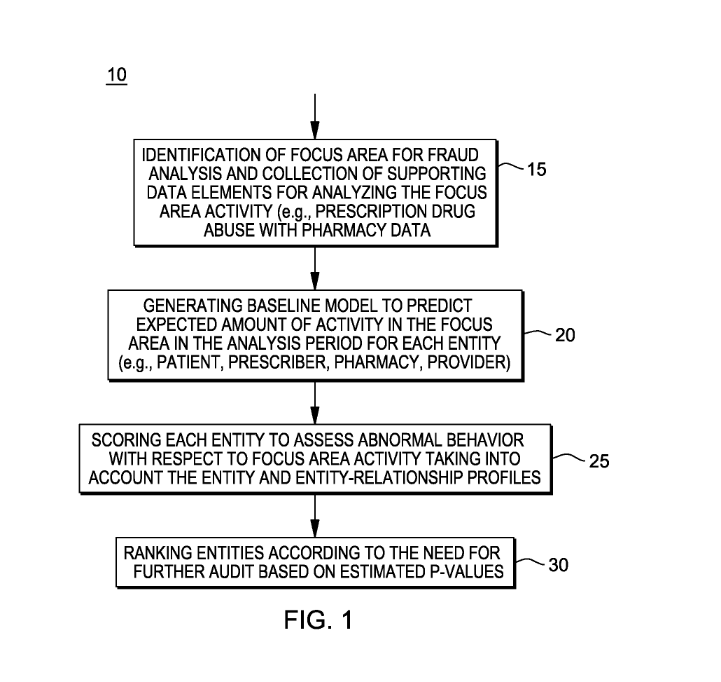

In connection with FIG. 1, a method 10 for detecting fraud in the health care industry, particularly in the context of prescription drugs, is provided.

Most cases of prescription drug fraud and abuse are associated with specific drugs which invariably belong to two categories: the first consists of high-volume drugs that can be resold to pharmacies and double-billed to the health plan, while the second consists of drugs that have high street value due to their association with non-medical and recreational abuse.

The method described herein focuses on the second category of drugs in a non-limiting exemplary way. The approach and methods described herein may easily be applicable for first type category drugs as well. In particular, the scenarios for analyses described herein are defined at the drug therapeutic class level.

FIG. 1 depicts a schematic overview 10 of the analytical methodology for identifying entities with potential abnormal claims behavior. The method includes steps including: at 15, the method invokes computer implemented processes for constructing a baseline model to predict the expected behavior of all entities in a selected focus area, wherein the focus area, as described above, corresponds to a specific drug therapeutic class level in which there is an expectation of significant fraud activity. This step 15 includes the collection of supporting data elements for analyzing the focus area activity (e.g., prescription drug abuse with pharmacy data).

The baseline model structure formed is used to predict expected amount of activity in the focus area in an analysis period for each entity, e.g., a data triplet including patient, prescriber, or pharmacy. Second, at 20, the method invokes computer implemented processes for scoring each entity based on its encounters in an analysis time window with respect to the baseline model. Third, at 25, the method invokes computer implemented processes for ranking and selecting scored entities as potential audit targets for fraud and abuse. This step includes scoring each entity to assess abnormal behavior with respect to focus area activity (e.g., excessive prescriptions for focus drugs), considering and after normalizing for the entity and entity-relationship profiles.

In one embodiment, for the health care domain auditing method described herein, various scenarios are considered corresponding to potential fraud instances for a certain focus area (in an analysis period) for each entity, which behavior of distinct auditable entities, e.g., patient, prescriber, pharmacy, provider, can be evaluated over the entire set of health care encounters. For each entity, any abnormal behavior is highlighted only if there were significant departures from the expected behavior posited by a normalized baseline model for that scenario.

The identification of the entities with abnormal behavior may then be based on a score, e.g., on a Likelihood Ratio (LR) score, which is computed from the actual behavior over the set of encounters for each entity, relative to the predictions of the normalized baseline model over this same set of encounters. In this embodiment, the statistical significance of this LR score is based on the relevant estimated p-values. The estimated p-values are obtained using appropriate methods, which may include analytical approximations to the distribution of the LR score, or using sampling estimates for the distribution using Monte Carlo methods.

Further, if necessary, statistical modeling methods may be further implemented that are robust to the presence of outliers.

The computer aided auditing method for health care domain auditing described herein: accommodates the complexity of identifying suitable scenarios; ensures the availability, correctness and sufficiency of the data for modeling; and implements new algorithms required for scalable and efficient model computation and hypothesis testing.

The computer aided auditing method described herein detects health care fraud and abuse in various scenarios including but not limited to: identity theft, fictitious or deceased beneficiaries, and prescription forgery.

In one embodiment, an assumption is that the majority of data to be audited consists of normal patterns of behavior, so that robust estimates are obtained for the baseline models. In particular, there is not requirement for explicit labels for abnormal transactions, since this information is typically not available, and when available may be of little relevance given the evolving nature of the abnormal patterns in the data due to fraud and abuse. In addition, it is noted that any abnormal behavior may not always be a consequence of fraud or abuse, since incomplete data, incorrect data and lack of context may also contribute to the observed abnormal behavior.

Finally, at 30, FIG. 1, the method performs ranking entities according to the need for further audit. The ranking of entities in order of the need for further audit may further be based on the estimated p-values.

In one example, any steps may be carried out in the order recited or the steps may be carried out in another order.

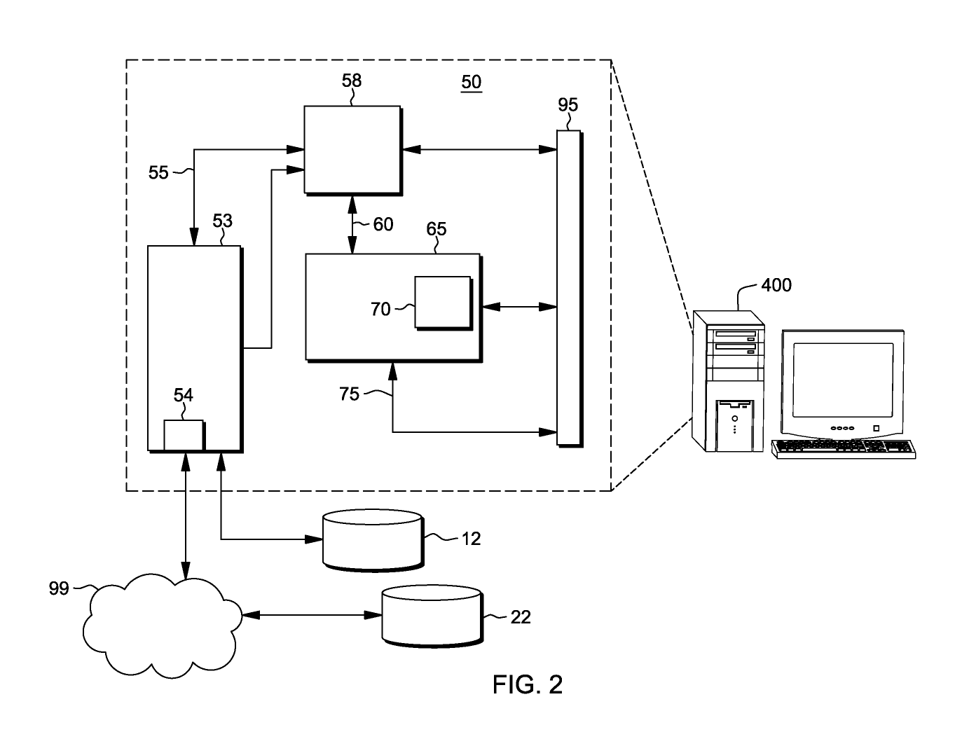

Referring now to FIG. 2, a computer system 50 for detecting fraud in the health care industry, particularly in the context of prescription drug claims, according to the processing methods shown in FIG. 1, is shown. In FIG. 2, the system 50 includes: an element 53 to receive healthcare information including patient drug prescription data, e.g., from electronic documents, e.g., digital records, stored in and accessed from a local connected memory storage device, e.g., medical database 12. Via a network interface device 54, healthcare information including patient drug prescription data may be received from a remotely located memory storage device, e.g., a database 22 over a communications network (e.g., a local area network, a wide area network, a virtual private network, a public or private Intranet, the Internet, and/or any other desired communication channel(s)) 99. The databases 12, 22 may include a medical claims and a prescription claims database having information and data including, but not limited to: individual records providing the information on the participating pharmacist, patient and provider, the formulary, the prescription frequency, length and dosage, and the claims and co-payment amounts. Further to this, in prior or contemporaneously executed method steps, all patient information and medical data is encrypted and anonymized in compliance with the regulatory and governmental, e.g., HIPAA, privacy requirements.

In non-limiting embodiments, the scope of the data in the prescription claims database may consider a certain time period, e.g., a 3 month period, in which claims records may number on the order of millions in which the distinct prescription formulary codes may exceed 19 thousand.

The databases 12, 22 may include other supporting data tables including a list of certified prescriber profession codes, prescriber specialty codes, and a drug classification table which may contain the packaging, dosage, formulation and drug therapeutic class for each individual formulary. Other relevant information such as the descriptive details for the International Classification of Diseases, 9th Revision (ICD-9) codes, the Current Procedural Terminology (CPT) codes, and the Clinical Classifications Software (CCS) codes, which may all be obtained from reliable public sources.

In addition to the prescription claims, databases 12, 22 may include a set of supporting medical claims data acquired for all the patients in the prescription claims database; this additional data may be obtained after an initial data analysis is performed, since the medical claims were deemed to be useful for constructing an objective profile for the patients and prescribers, and for establishing the medical context for individual prescription claims.

In one embodiment, for the audit analyses corresponding to a certain analysis time window of interest, the method includes profiling prescribers by their top diagnoses codes and procedure codes from the medical claims data in a certain history time window (this history time window typically consists of the period that leads up to and includes the analysis time window). The method includes profiling patients according but not limited to: gender, age interval, and by their medications taken in the history time window. In one embodiment, the medications are abstracted to the drug therapeutic class level to avoid a proliferation of profile elements corresponding to equivalent or similar medications.

Further in FIG. 2, a processing element 58, in operative communication with the receiver component 53, is configured to process the input medical claims and prescription claims data 55 producing a baseline model to predict the expected behavior of all entities in a (e.g., prescription drug) focus area. This step includes the identification of focus area or one or more fraud scenarios and collecting supporting data elements—from a sparse (high dimensional) data input space—for analyzing the focus area activity.

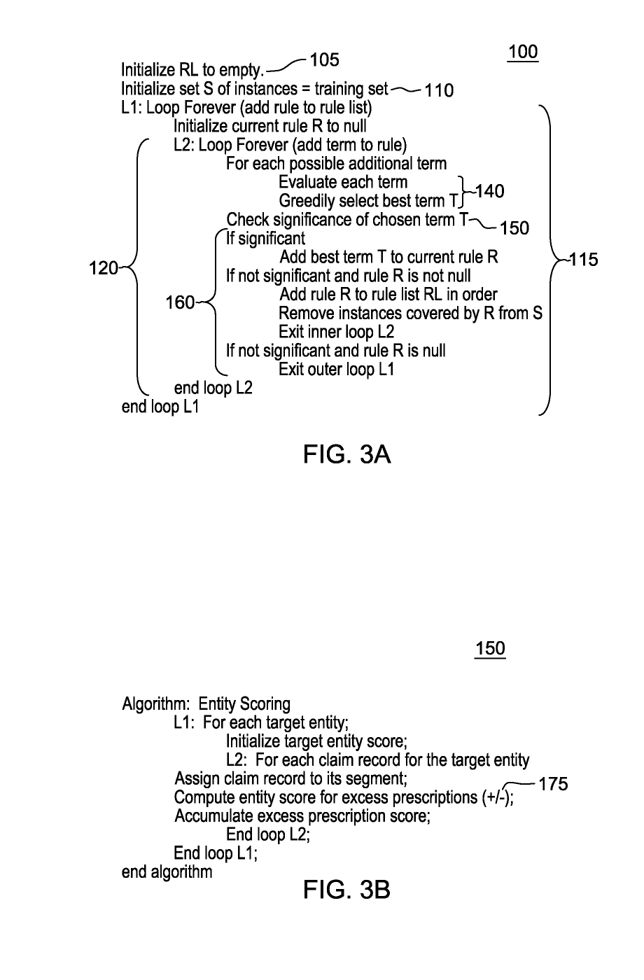

A rule generating processing component 65 operating in conjunction with baseline model generator 58 performs method steps for obtaining the normalized baseline models 60 in a scalable and efficient way. The rule generating processing component implements a rule-generation algorithm, described herein with respect to FIG. 3A, that generates a rule list model 75 tailored to the characteristics of the sparse data in the domain. All the inputs (of the sparse data input space) to element 65 may be either naturally in binary form (e.g., presence or absence of diagnoses or procedures), or may be transformed into binary form by binning (e.g., age). Correspondingly, the structure of the rule list model 75 is an ordered list of rules where each rule is a conjunction of terms and each term specifies either the presence or the absence of some input binary variable.

The rule list model structure to segment the sparse high dimensional input space into relatively homogeneous segments with respect to the prescription rates have a transparent structure, which allows for an easy inspection and validation of the model details by expert audit investigators. Thus, in one embodiment, an interface component 95 is provided configured to provide an investigator or health care domain expert to edit, e.g., inspect and validate details of the rule list model 75. The interface 95 is in operative communication with each of the system components 58 and 60 provides a visual outputting element (such as an interface display screen or the like) and/or an audio outputting element (such as a speaker or the like) for user interfacing. More particularly, it is via user interface 95 that enables a user to inspect and validate (and through feedback, improve) the rule list.

Further shown in FIG. 2 is an entity scoring processing component 70 operating in conjunction with the rule list generator 65 performs method steps for scoring each entity according to an entity scoring algorithm, described herein with respect to FIG. 3B, that generates a score quantifying an entity's excessive rate, e.g., prescriptions, which indicate that entity's potential for fraud/abuse of in the focus area for the analysis time window.

Further to the system 50 of FIG. 2, there is included an associated (local or remote) memory storage device and connectivity tools configured to store and/or access a toolkit of data models, algorithms, result models and templates with use cases for implementing the methods described herein. In one aspect, the system employed may employ JDBC (i.e., Java Database Connectivity) and/or System Query Language (SQL) commands for database accessing and processing. The system may further employ SPSS® an IBM (International Business Machines, Inc.) predictive analytics software product used for statistics and statistical modeling. Use of the IBM SPSS Modeler product provides a workbench for creating data mining and statistical modeling applications. In, general a component framework may be implemented providing programming interfaces for enabling new predictive methodologies in the SPSS modeler. One application programming interface (psapi) in particular, enables accessing the underlying predictive methodologies in SPSS from an external application such as an accelerator/warehouse which may comprise: an application server comprising of claims data to be analyzed for fraud, various driver tables, and various feature sets that are obtained for potential fraud detection. An example is the IBM FAMS (Fraud and Abuse Management System) platform. Further, various methods are deployed in the accelerator/warehouse using an application development framework for adding new fraud scenarios. It is understood that the accelerator/warehouse may be configured to perform analytics computations within the database (i.e., either on the same hardware, or within the address space of the running database server)—usually with stored procedures or user defined functions.

Thus, in one embodiment, the system in FIG. 2 for augmenting and improving fraud detection capabilities employs: the accelerator/warehouse representing a fraud analysis system including claims data stores, claims data processing, and results reporting for fraud investigation; the processing components shown in FIG. 2 for providing augmented capability using the methods described herein; and, the aforementioned SPSS Modeler workbench to develop new use cases and fraud scenarios based on the methods and the algorithms described, and provide these use cases and scenarios as a service that can be invoked from the accelerator/warehouse as part of the fraud detection processing workflow.

### Baseline Model Structure

The baseline model is developed separately for each focus drug class (a focus area item). Each distinct combination of a prescriber (e.g., physician, nurse practitioner), a patient and a pharmacy that is encountered in the analysis time window period in the prescription claims data represents an instance for learning the baseline model. In a prior step, there is performed identifying and linking profile information from the multiple data sources providing health care information regarding patient and prescriber encounters. This information may be obtained from tables and may include non-claims data for all other entities in the claims database. For each instance, the counts of the total number of prescriptions and the counts for prescriptions of the focus drug therapeutic class are obtained, and the proportion of these two quantities is the “prescription rate” outcome variable to be modeled.

In one aspect, the method includes generating the baseline model by learning the relationship between patient and prescriber profiles, and the rate of focus drug prescriptions. The methodology may further incorporate pharmacy characteristics. While there are many possible model structures that can be used for obtaining the baseline models, the method implements a rule list model structure to segment the sparse high dimensional input space into relatively homogeneous segments with respect to the prescription rates. These models have a transparent structure, which allows for an easy inspection and validation of the model details by expert audit investigators.

The rule list model structure further provides the ability to capture the broad segments of prescribing behavior for any focus drug class that can be determined using only claims data. The algorithm to generate the rule list model is described in greater detail herein with respect to FIG. 3A.

In a further embodiment, as predicting whether a prescription for a certain focus drug class will be given in any specific encounter between a prescriber and a patient may require detailed information about the patient profile (e.g., health status, diagnostic history and test results) and the prescriber profile (e.g., specialization and clinical expertise), the prescription claims and medical claims data in databases 12, 22 further includes and/or be linked to incorporate the relevant patient profiles and medical history in the analyses, to improve the quality of the baseline model predictions.

In one embodiment, the prescriber and patient profiles are represented in a sparse binary form. For each prescriber, the profile elements include the top number of diagnoses, e.g., top five diagnoses (abstracted to the first three digits/characters in the ICD-9 taxonomy), and the top number of procedures performed, e.g., top five procedures, abstracted to the corresponding CCS classifications for single level procedures developed by Agency for Healthcare Research and Quality. For the patient, the profile elements include gender and age intervals which may be dummy-encoded to separate out children under 11, with the remaining population in 20-year interval bins, etc. In addition, the patient profile elements also include their drug history in the history time window, which are represented in terms of the usage in the drug therapeutic class (e.g., about 90 such classes); however, any history in the scenario focus drug class itself is excluded from the relevant patient profile for that scenario.

### Rule List Model Generation

The algorithm for rule list model generation is tailored to the characteristics of the sparse data in this domain. All the inputs are either naturally in binary form (e.g., presence or absence of diagnoses or procedures) or have been transformed into binary form by binning (e.g., age). The structure of the rule list model is an ordered list of rules where each rule is a conjunction of terms and each term specifies either the presence or the absence of some input binary variable. As in any ordered rule list model, an instance is said to be covered by a particular rule R if it satisfies the conditions of rule R but not those of any rule preceding R in the rule list. Hence, the rule list partitions all instances into disjoint segments corresponding to each of the rules and a default segment covering instances not covered by any rule in the list. There is a predicted rate of focus drug prescriptions associated with each segment (including the default segment).

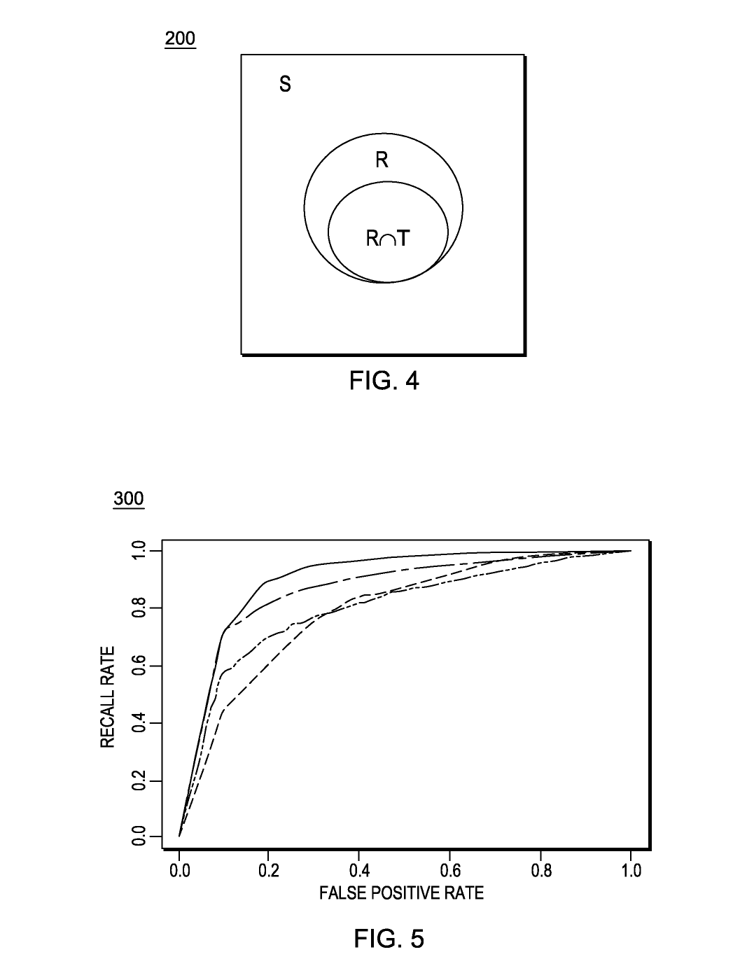

FIG. 3A depicts the rule list generation algorithm 100. In the Generate Rule List Algorithm: initially, at 105, a rule list RL is initialized empty, and all the training instances to be covered are received and stored at 110. Processing at each iteration of the outer loop 115 potentially adds a rule R to the rule list RL. Processing at each iteration of an inner loop 120 potentially adds a term T to the current rule R being generated. The criterion used to select the term T for possible addition to the rule R and the stopping criteria for rule refinement and rule list expansion are tailored for this application. The processing that includes adding a candidate term to the rule includes selecting the candidate in a greedy fashion at 140, e.g., using a metric from a Likelihood Ratio Test (LRT) as described herein with respect to FIG. 4.

FIG. 4 conceptually depicts a method 200 for the greedy term selection. The method 200 includes selecting a term greedily, e.g., based on Likelihood Ratio Test Score. For each updated rule R that includes a term T being evaluated, at 140, the LRT includes comparing two hypotheses for modeling the set of instances S at that point. The alternate hypothesis models the instances covered by the rule R and the remaining using separate Bernoulli distributions using their respective mean rates. This is depicted in FIG. 4 as modeling R∩T instances separated from the rest of S. The null hypothesis models the entire set of instances S with a single Bernoulli model using the mean rate over S. The method includes selecting terms T and hence rules R that cover a subset of instances that have significant deviation from the remaining set of instances in S.

Returning to FIG. 3A, in one embodiment, this selection includes checking the chosen term at 150 using a significance test at 160 that uses the hypergeometric distribution to determine the probability P of getting as high an LRT score with any random set of instances with the same cardinality as C. A parameter is passed to the rule generator component to specify the threshold on this probability. This probability threshold parameter may be specified by a user via the interface and received at the rule generator component 65. Terms and rules are added only if the probability P is lower than a user specified threshold.

It is noted that rules R can focus on shifts from population in either direction (either high or low). The candidate term T is included in rule R only if refinement of R due to R as measured by LRT is significant as measured against the threshold probability parameter specified. This is reflected in processing at 160, FIG. 3A, which includes determining based on the p-value estimate if the current term T is significant, then adding the best term T to the current rule R. If a determination is made that the current term T is not significant AND rule R is not null, then the method adds rule R to rule list RL in order. Further, the method includes removing instances covered by R from S and the inner loop L2 processing 120 is exited. Otherwise, if current term is determined not significant AND rule R is null, then the outer loop L1 processing is exited. This method may be performed without a separate pruning phase.

For the prescription health care example, the system and methodology “learns” a sequential list of rules from the data that “explain” the rate of target drug prescriptions. In an example, 12 explicit rules in this ordered list are generated: R1, R2, R3, . . . , R12. So any case (instance) will be either be covered by one of these rules or fall into a “default” situation where no rule covers it. So there are 13 possible ways for a case to be “covered” by the rule list in the example.

The method further includes processes for grouping the cases (instances) by the way they are covered by the rule list. For the example, there will be 13 groups. These groups are alternately referred to herein as “segments”, as they segment the entire input space of cases into disjoint groups. It is noted that there exists a correspondence between segments and rules in the rule list. In the example above, there are 12 segments that correspond to each of the 12 rules in the rule list. And there is a 13th segment that corresponds to the “default” case where no rule covers the case.

In one embodiment, rule generation at processing element 65 mixes in rules with either low or high rates in the ordered rule list being generated based on the LRT metric. Secondly, considering a hypothetical stage in the rule generation where the instance space S to be covered has a total prescription count of 1000 and a focus drug count of 20, corresponding to a rate of 2%, i.e., S: (total prescription count, narcotic count, rate)=(1000, 20, 2%): Suppose there were two interesting choices of binary variables to build the next rule. Choice A partitions the space into two sub-spaces with (total count, focus drug count, focus drug rate) values each. That is, for example, a Rule R1 partitions S into (400, 19, 4.75%) and (600, 1, 0.17%). Choice B, a Rule 2, on the other hand, partitions the space S into two sub-spaces with (total count, focus drug count, focus drug rate) values of (9, 5, 55.6%) and (991, 15, 1.51%). The LRT based heuristic processing described herein selects choice A and is consistent with building rules with significant evidence in the data and ties in with the approach used for entity scoring. This also helps avoid over-fitting of the generated rules to the training data.

The LRT based heuristic described herein makes the rule refinement process and rule list generation to be self limiting and tends to generate rule lists that do not over-fit the training data when the user defined threshold for P is set quite low (e.g., 0.0001). The number of segments and their sizes are not explicitly controlled with user specified parameters, but rather these are a consequence of the implementation of the recursive partitioning process as the sequential list of rules that are generated using the heuristic based on the significance tests described above.

The last step in the generation of the rule list based baseline model is to determine the predicted rates of the focus drug class. For each segment induced by the rule list model, the predicted focus drug class rate is the mean rate observed in the training set instances covered by the segment. Some segments do cover situations where high rates of focus drug prescriptions are expected and others do cover circumstances that typically have very low rates.

Rule generation does not depend on a particular entity. It focuses on the scenario, which is defined as the set of encounters between patient, prescriber and pharmacy and is based on the rate for each such set of encounters. The baseline model based on the rule list generated can be applied to compute excess prescription scores for any type of entity: prescriber, patient or pharmacy. There is only one model for each focus drug and one pair of analysis and history time windows.

### Entity Scoring for Abnormalities

The rule list baseline model represents the expected behavior for focus drug prescriptions under various circumstances as represented in the rules involving patient and prescriber characteristics. The next step in the methodology is to score the target entities (prescriber, patient or pharmacy) quantifying their excessive prescriptions for the focus drug item as measured by the deviation from the baseline model. It is important to note that a target entity can have prescription activity that falls into more than one segment. A simple example of this could be a physician who when prescribing for a child is covered by a different segment (rule) compared to when prescribing for an adult. The scoring for an entity aggregates the deviation from the baseline model over all the segments that the prescription activity falls into. The scoring for an entity reflects the magnitude of the deviation and the volume of transactions with excessive prescription rates. In one embodiment, scoring is based on Likelihood Ratio Tests.

In one embodiment, the scoring for excess rate takes place at the level of the segment. A segment will be defined by prescriber specialty, diagnoses, medications prescribed, patient demographics, treatments, fulfilling pharmacy, and so on. Segment level scores are aggregated for the target entity type (e.g., prescriber). This approach will is sensitive to the context in which the prescription was written. For example, the narcotics prescription rate should be different for pediatric patients versus adults.

FIG. 3B depicts an algorithm for implementing entity scoring. The algorithm 150 in FIG. 3B operates a first outer loop L1 including processing to evaluate each target entity. Each target entity score is first initialized. Then, a second inner loop is operated wherein, for each claim record for the target entity, there is performed the steps of: assigning the claim record to its segment; computing the entity score for excess prescriptions (+/−) as indicated at 175; and accumulating excess prescription score. After these steps, the second inner loop ends and the first outer loop ends.

More particularly, in one embodiment, the score for an entity E (e.g., a prescriber) is computed as follows: Considering each segment “Seg” defined by the baseline model. In this segment Seg, let A be the total count of prescriptions in Seg and F be the count for the subset corresponding to focus drug prescriptions. The expected rate of focus drug prescriptions for this segment is F/A. Consider all the data instances d for entity E that belong to the segment Seg. Let variables “a” and “f” be the counts for all prescriptions and focus drug prescriptions in “d”, respectively. Then the contribution to the score for entity E from this segment Seg is given by computing the log likelihood ratio based on the Bernoulli distribution. At 175, FIG. 3B, the score contributions for entity E from each segment Seg are aggregated by summing up after assigning a sign to each contribution based on whether the focus drug rate for the entity in that segment was higher (+) or lower (−) than the expected rate in the segment.

Score(E,Seg)=f log f/a+(a−f)log(a−f)/a+(F−f)log(F−f)/(A−a)−F log F/A−(A−F)log(A−F)/A+[(A−a)−(F−f)]×log [(A−a−F+f)/(A−a)]

In a further embodiment, the method includes transforming the entity scores to more meaningful values by estimating the corresponding p-values. Monte Carlo methods provide a direct way for estimation. The distribution of these scores under the null hypothesis as represented by the baseline model is determined empirically by performing N randomized experiments as follows: In each experiment, a synthesized data set is created where the number of focus drug prescriptions for each instance I is determined using pseudo-random generators modeling the Bernoulli distribution with the focus drug rate expected for the segment that instance I belongs to. The maximum score achieved by any entity using this synthesized data set is recorded. The set of these maximum scores achieved in the N Monte Carlo experiments is used to transform the entity score to the estimated p-value.

Examples of experimental results from an analysis of prescription claims over a time period or window, e.g., three month time window, in a given year for all the focus drug classes is now discussed. First, the ability of the baseline models to explain the need for focus drug prescriptions is assessed. Then, the method applies these baseline models to score and rank entities based on their abnormal behavioral patterns of excessive prescriptions for each of these focus drug classes.

For baseline modeling evaluation, the baseline model may be evaluated using a 50-50 training/test split of the data. FIG. 5 shows a plot 300 of an example the Receiver Operating Characteristic (ROC) curve for the four focus drug classes of the example described herein. The solid, dash-dotted, dotted and dashed lines correspond to model runs for amphetamines, tranquilizers, CNS stimulants and narcotic analgesics, respectively, and the ROC curves 350 show the tradeoff between sensitivity (recall rate) and specificity (false positive rate) with the area under each ROC curve (AUC) as an accuracy metric that speaks to the accuracy of the baseline model partitioning.

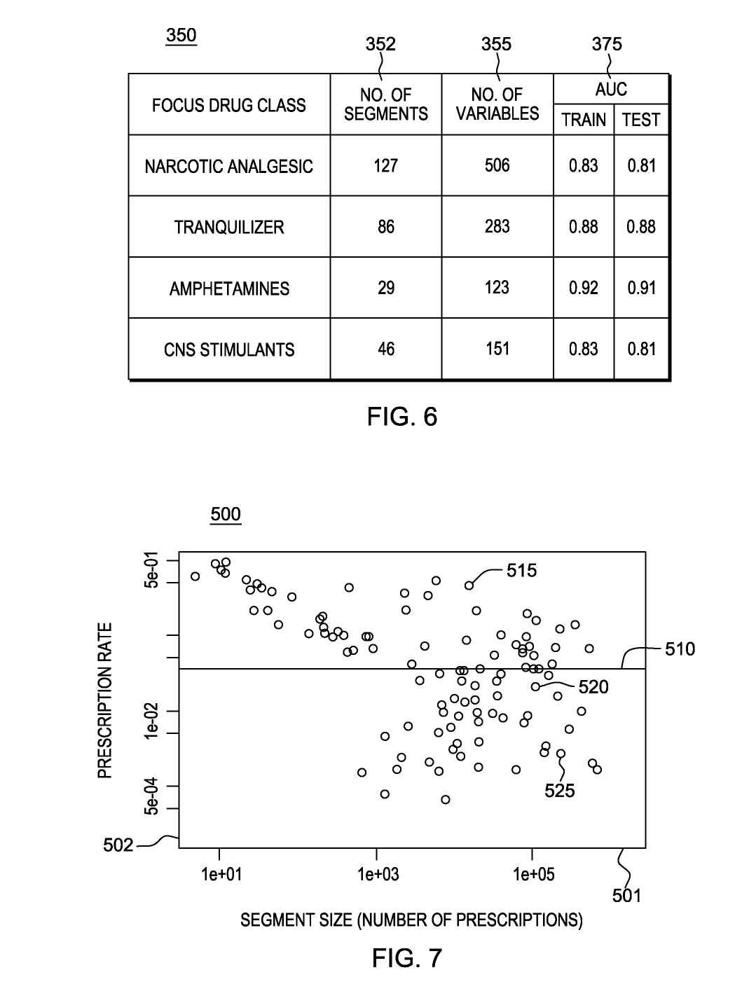

FIG. 6 depicts a Table 350 illustrating the key characteristics of the baseline model including the area under the ROC curve (AUC). The AUC metrics 375 achieved (e.g., in the range 0.8-0.9) for both training and test sets indicate an acceptable baseline model that does not over-fit the training data.

In an example, the number of segments in the baseline model ranges from 29 to 127 considering the four drug classes. The number of variables used as terms in the rule list range from 123 to 506. The baseline model for the narcotic analgesic class is the most complex utilizing 506 variables in the rule terms out of the 1281 available binary variables. The baseline model for the narcotic analgesic class is now further described:

FIG. 7 shows a plot 500 of example narcotics prescription rates 502 by segment size 501. Some examples of segment defining rules that were generated in an example baseline model for the narcotic analgesics drug class include, in a non-limiting way:

A rule with 29 terms covers children ages 10 and under and predicts them to have very low rates (0.16%) of prescriptions for narcotic analgesics compared to the base rate across the entire population (3.5%) when they are not seen by prescribers who perform various surgical and dental procedures. (Approximately 319K and 329K instances are covered by this rule in the training and test set, respectively.)

A rule with 62 terms covers patients ages 11 through 70 who are taking muscle relaxants but are not on certain other medications (e.g., for diabetes) when they see certain types of prescribers (e.g., exclude gastroenterologists, exclude prescribers treating the lacrimal system) and predicts that they will have a moderately high narcotic analgesic prescription rate (15.3%). (Approximately 88.6K and 90.9K instances are covered by this rule in the training and test set, respectively.)

A rule with 21 terms covers older patients (age>70) and predicts them to have low rates (0.19%) of narcotic analgesic prescriptions if they are not also taking muscle relaxants, certain antibiotics and have not been administered certain local anesthetics and when they are not seeing prescribers who typically perform various surgical procedures. (Approximately 147K and 140K instances are covered by this rule in the training and test set, respectively.)

As illustrated in FIG. 6, rules 352 can have many variables 355, i.e., terms to include or exclude patient conditions based on their medications and the type of prescribers they are seeing. The number of such variables 355 is the union of all the terms that appear in the set of rules 352. Review of some of these rule terms 355 with domain experts suggests that rules are extracting patterns from the instances data set that conform to known phenomena like drug/disease or drug/drug interactions (e.g., narcotic analgesics and hypothyroidism). These patterns are not easy to incorporate into investigations, and are difficult to identify if this analysis is done manually as part of a fraud investigation.

The model induces segments whose sizes span several orders of magnitude, as seen in FIG. 7. FIG. 7 shows a graph 500 plotting a measure of segment size (i.e., a total number of prescriptions covered in the training and test sets) on the x-axis 501 (e.g., log scale) and the rate of narcotic analgesic drug prescriptions on the y-axis 502 (log scale). The horizontal line 560 marks the overall base rate of around 3.5% for narcotic analgesics. In this example, the model has identified small and medium size segments with relatively high rates and some medium and large segments with low rates.

In the characterization of segment performance versus size shown in FIG. 7, there is depicted a first example segment 515 of example count of 12.7K prescriptions, and a computed prescription rate=53%, e.g., for patients <71 years of age having other or therapeutic procedures on joints; a second example segment 520 is for an example count of 710.9K prescriptions, prescription rate=14%, e.g., for patient ages 11-70, being prescribed muscle relaxants; and a third example segment 525 of example count of 1,376K prescriptions, and a computed prescription rate that is very nearly 0%, e.g., for patients 0-11 years.

FIG. 7 also illustrates that there is room for improvement in the baseline model by having more of the identified segments (big and small) have expected rates significantly higher or lower than the overall base rate. As mentioned earlier, with clinical data one would expect encounter level prediction for a drug class prescription. Further, using patient linked diagnoses and procedure codes will help improve the baseline model significantly. For example, one of the rules 515 indicates that high rates of narcotic analgesic prescriptions (53%) are expected when patients see prescribers performing surgical procedures on joints (with some exclusions whose details are omitted here).

The model can be refined further with data on procedures and diagnoses linked to patients. This additional data allows further separation of encounters that involved, for example, orthopedic surgeries from those that simply were consults not leading to any surgical intervention.

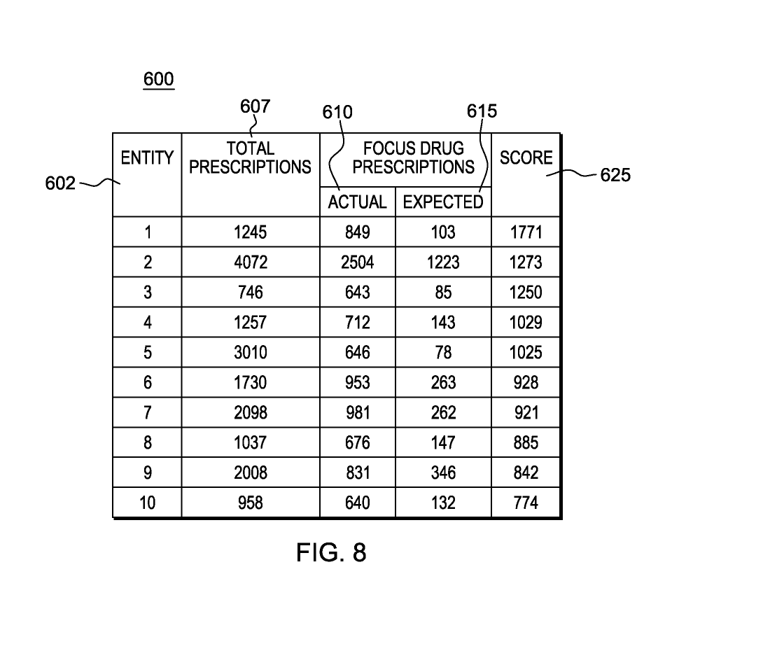

Referring now to FIG. 8, there are depicted examples of entities identified by the model and particularly example results of the modeling used to predict expected amount of activity in the focus area in the analysis period for a prescriber entity for the example described. The computer system programmed to perform the analysis techniques herein can be used to predict focus area activity for a patient, pharmacy or a provider as well.

In FIG. 8, Table 600 depicts characteristics of some prescriber entities 602 (e.g., prescribers) identified by the model as being abnormally excessive in the prescribing of narcotic analgesics and shows computed entity scores 625. Particularly, as shown in FIG. 8, table 600 depicts actual counts 610 for the respective focus drug prescriptions and total prescriptions 607 in a time period or time window, e.g., a 3 month analysis window or any time period, for these prescribing entities 602. The expected number 615 of focus drug prescriptions estimated by the baseline model is also shown. The very high LR based scores 625 for these entities correspond to p-values<0.0001 (a very high confidence). It is noted that the expected rate for narcotic analgesics for these entities ranges from 2.6% to 30%, considering all their encounters with patients. Their scoring, which is shown in FIG. 8 in ranked order of indicating activities being abnormally excessive takes into account these widely varying expectations on prescribing behavior for narcotic analgesics.

The validation of the entities identified by the model as being abnormal and excessive in focus drug prescriptions may be performed at various levels of rigor and human expert involvement. A first level of validation includes determining if the model identified list includes the few known cases of fraud.

In one embodiment, via the user interface of the computer system shown in FIG. 2, investigators and audit experts, for example, perform a further level of validation by manually evaluating whether a sample of the specific entities identified by the model are suitable candidates for further investigation.

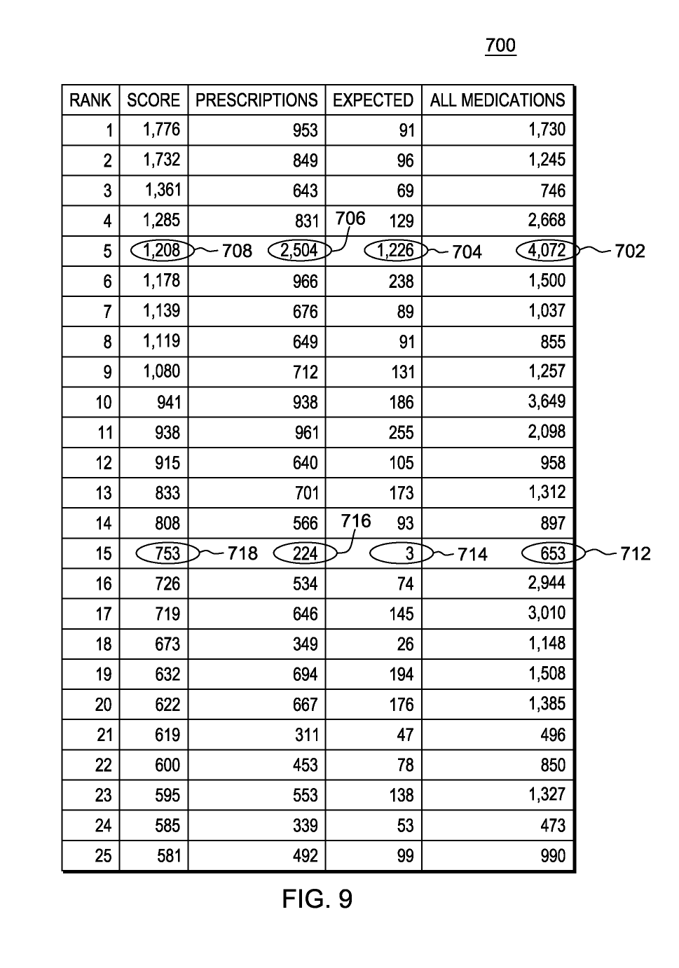

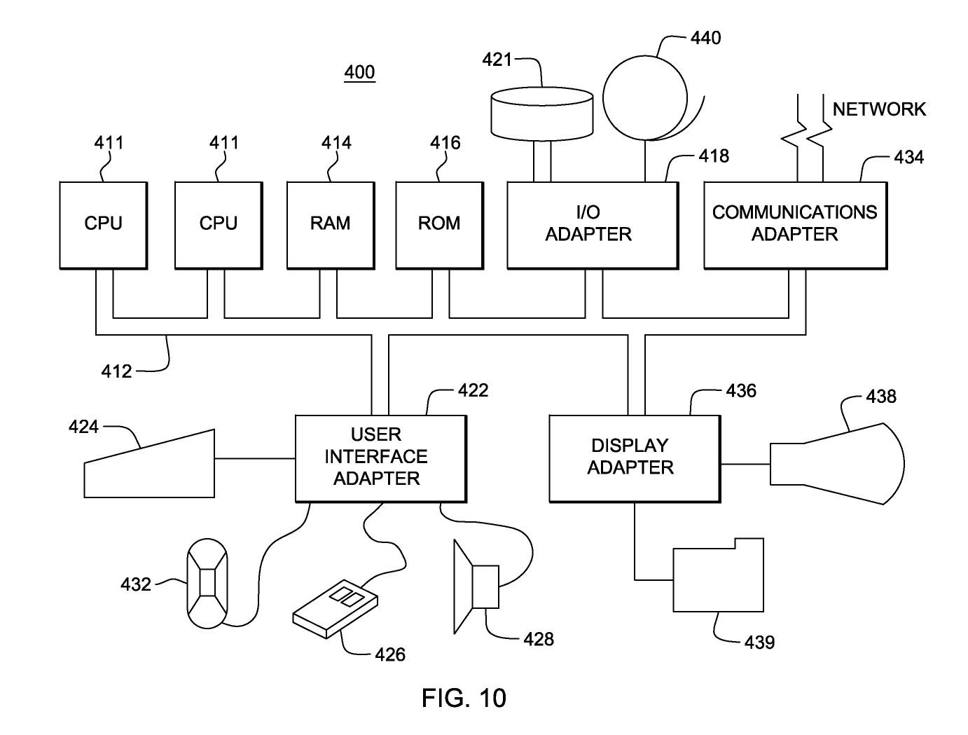

For example, as shown in FIG. 9, the methodology considers a given focus area or scenario in the health care claims context, and obtains ranked lists that selectively identify entities with behavior that is indicative of potential fraud and abuse in this scenario.

FIG. 9 shows example results 700 generated as output of the processing described herein computed as a ranked list of the top potential target entities for narcotic analgesics (an example focus drug class). The plot illustrates how the excess prescription score goes beyond simple prescription volume. Via the user interface 95 depicted in FIG. 2, an auditor presented with the data may analyze and isolate potential target entities for further investigation. For example, the entity with rank 5 is isolated as having the fifth highest excess prescription score 708 yet would rank first based on high total medications 702 if not for the high expected number of prescriptions 704 against which the high actual number of prescriptions 706 is compared; and the entity with rank 15 with relatively high excess prescription score 718 which might be unexpected given the relatively high total medications 712 if not for the low expected number of prescriptions 714 against which the low actual number of prescriptions 716 is compared.

As the generated baseline model is able to capture the relevant normalization from the data at finer level of granularity than the peer group, namely, at each individual and distinct encounter between the prescriber and patient, the approach described herein extends beyond mere normalizing the expected behavior of each entity based on the consideration of their peer groups at the entity level.

The models and methodology described herein, by virtue of using detailed patient and prescriber profiles based on a considerable amount of relevant context that includes medications, diagnoses and procedures, will detect “under-the-radar” cases where claims and supporting data have been misreported or intentionally falsified to cover the fraudulent behavior.

Further, the models and methodology described herein do not require any labeled examples of actual fraud where, in the context of health care, the nature and scope of fraud is constantly changing and often unknown, with less scope for ascertaining labeled examples for these in a timely manner during the processing of the health care claims. However, the absence of labeled data should not affect the estimation of the baseline models; the assumption of the methodology is that the instances of abnormal behavior will be satisfied if the number of these instances is relatively small, with the robust methods used for the estimation of the baseline models described herein.

In a further embodiment, the initial baseline models can be re-estimated and improved by removing the abnormal instances and entities that have been initially identified. This approach, in an iterative manner, can be used to finalize baseline models without the possible effects of the high statistical leverage due to the instances of abnormal behavior in the data.

The methodology described herein has been applied to prescription claims data, and it can be readily extended to many other fraud and abuse scenarios in the health care context, e.g., for health care claims in fee-for-service plans.

FIG. 10 illustrates one embodiment of an exemplary hardware configuration of a computing system 400 programmed to perform the method steps described herein above with respect to FIGS. 1, 3A, 3B and configured as the system described with respect to FIG. 2. The hardware configuration preferably has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting the system 400 to a data processing network, the Internet, an Intranet, a local area network (LAN), etc., and a display adapter 436 for connecting the bus 412 to a display device 438 and/or printer 439 (e.g., a digital printer of the like).

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While there has been shown and described what is considered to be preferred embodiments of the invention, it will, of course, be understood that various modifications and changes in form or detail could readily be made without departing from the spirit of the invention. It is therefore intended that the scope of the invention not be limited to the exact forms described and illustrated, but should be construed to cover all modifications that may fall within the scope of the appended claims.

1. A method for computer-aided audit analysis comprising:
formulating a set of scenarios each relating to a collection of encounter instances for a health care domain focus area;
collecting supporting data elements for analyzing activity of the health care domain focus area in an analysis period;
creating a baseline model associated with each scenario in the set of scenarios using said data elements to create an expected rate of activity for one or more said entities with respect to said focus area, said entities comprising: patients, prescribing entities (prescribers), and pharmacy entities (pharmacies), said set of scenarios relating to instances of encounters between said patients, prescribers and pharmacies, wherein said patient and prescriber encounters include issuing prescriptions, by a prescriber, to patients for a focus area drug item;
predicting from said created baseline model an expected amount of activity concerning said focus area in the analysis period for an entity; and
computing a score for the entity using said baseline model, said score used to assess abnormal behavior with respect to said focus area activity, wherein a computing system including at least one processor unit performs one or more of: the collecting, baseline model creating, predicting and scoring.

2. The computer-aided audit analysis method as in claim 1, wherein said collecting specific data elements comprises:
obtaining from a data source, activity data regarding said patient and prescriber encounters used for said analyzing, said activity data comprising:
first quantity data representing a total number count of prescriptions prescribed by an entity; and
second quantity data representing a number of prescriptions of the focus drug item by said entity,
wherein a proportion of said first and second quantities is a prescription rate of said focus item associated with said prescriber.

3. The computer-aided audit analysis method as in claim 2, wherein said collecting specific data elements comprises:
identifying and linking data representing patient profiles and data representing prescriber profiles from said data source,
said baseline model creating further including learning a relationship between said patient and prescriber profiles and the prescription rate of said focus drug item.

4. The computer-aided audit analysis method as in claim 3, wherein said the prescriber and patient profile data is represented in a sparse binary form, said baseline model including said prescriber and patient profile defining a high-dimensional input space.

5. The computer-aided audit analysis method as in claim 4, further comprising:
generating an ordered rule list structure by segmenting said high-dimensional input space into homogeneous segments, a prescription rate of said focus item associated with each segment.

6. The computer-aided audit analysis method as in claim 5, wherein each rule R of said list comprises a conjunction of terms, each term specifying either the presence or the absence of input binary variables, wherein said patient and prescriber encounter instances satisfy conditions of a rule R but not those of any rule preceding it in said ordered list.

7. The computer-aided audit analysis method as in claim 6, further comprising:
selecting terms to including in each rule R of said list according to greedy term selection based on a Likelihood Ratio Test metric.

8. The computer-aided audit analysis method as in claim 7, wherein said greedy selection said term based on a Likelihood Ratio Test metric further comprises:
comparing two hypotheses for modeling a set of instances S: a first hypothesis modeling the instances covered by the rule R and the remaining set of instances using separate Bernoulli distributions using their respective mean rates; and a second hypothesis modeling the entire said set of instances S with a single Bernoulli model using a mean rate over S; and
selecting terms T for a rule R that covers a subset of instances that have significant deviation from the remaining set of instances in S.

9. The computer-aided audit analysis method as in claim 6, wherein said computing a score for an entity to assess abnormal behavior comprises:
aggregating a deviation from the baseline model over all the segments that said focus area activity falls into, wherein said score reflects a magnitude of the deviation.

10. The computer-aided audit analysis method as in claim 9, wherein said scoring further comprises:
estimating p-values for said scores for each entity; and
ranking scored entities according to their corresponding p-values, wherein ranked entities indicate potential entities for audit investigation.

11. The computer-aided audit analysis method as in claim 3, wherein the linked patient profile data includes a patient's age, gender, health status, diagnostic history and test results relating to activity in said focus area, and the prescriber profile includes data representing the prescriber specialization and clinical expertise.

12.-27. (canceled)
